(19) United States
(12) Patent Application Publication
(10) Pub. No.: US 2020/0267947 A1
(43) Pub. Date: Aug. 27, 2020

(54) ARRANGEMENT AND METHOD FOR MEASURING THE BIOLOGICAL MASS OF FISH, AND USE OF THE ARRANGEMENT

(71) Applicant: iTecSolutions Systems & Services AS, Flekkefjord (NO)

(72) Inventor: Svein K. KROSSLI, Kvinesdal (NO)

(73) Assignee: iTecSolutions Systems & Services AS, Flekkefjord (NO)

(21) Appl. No.: 16/303,882

(22) PCT Filed: May 24, 2017
(86) PCT No.: PCT/NO2017/050131

§ 371 Date: Nov. 21, 2018

(30) Foreign Application Priority Data
May 24, 2016 (NO) 20160880

(51) Int. Cl. A01K 61/95; G01B 11/24; G01G 17/08

(52) U.S. Cl. CPC A01K 61/95; G01G 17/08; G01B 11/24

(57) ABSTRACT

The invention provides an arrangement for measuring the biological mass of fish, the arrangement comprising a measurement unit and a processing unit operatively connected to or integrated in the measurement unit. The measurement unit comprises one of: a camera comprising an integrated autofocus function or an external distance measurement device providing data on distance between fish and camera, and a stereovision film camera; the measurement unit or the arrangement comprises sources of in substance monochromatic light, and the processing unit comprises: a pattern recognition functionality and function for creating an outline of said fish after a positive finding, the outline comprises length and at least one transverse dimension across the length of the fish being measured, or an area inside the outline and at least one of length and a transverse dimension across the length of the fish being measured, all other data are eliminated and the outline is used to calculate or find the biological mass of the fish. The invention also provides a method for measuring the biological mass of fish.

### FIELD OF THE INVENTION

The present invention relates to fish and measurement of the biological mass, also termed biomass of the fish, that is, the weight of the fish. Typical use of the invention will be in fish farming of salmon or other fish.

### BACKGROUND OF THE INVENTION AND PRIOR ART

Currently there is no technology available having sufficient accuracy for measuring the biological mass or weight of fish in a net cage. The existing methods count the number of fish and require the fish to be in a specific position, in a conduit or a box. The problem is that the fish will not swim into a box or a conduit. In addition, for fish swimming through or falling down a conduit, a specific speed of movement will often be required.

Reference is made to the nearest prior art, U.S. Pat. No. 1,68,151 according to which the number of fish is counted by measuring fish as falling down a conduit in front of a CCD line camera, whereby the area of shadow registered by the camera represents the area of an individual fish. A resulting accumulated area of fishes is then divided by an average fish area and the number of fish is found.

However, the condition of fish vary a lot. The relationship between length (L) and weight (W) for fish can be expressed as:

W=αL^{b}

For fish having identical shape independent of size, as sometimes found for salmonids, the factor exponent b is 3, which is according to the cube law. The exponent b and factor a vary between species.

The condition factor, K, is another measure of an individual fish's health that uses standard weight. Proposed by Fulton in 1904, it assumes that the standard weight of a fish is proportional to the cube of its length:

K=100(W/L³)

where W is the weight in grams and L is the length in centimeters; the factor 100 is used to bring K close to a value of one. For fat fish K is above 1, for thin fish K is below 1.

Experience show that the condition factor vary a lot, also in the same population and over time, so depending on measuring length, area or number of fish and assuming average condition factors result in inaccuracy.

Furthermore, the fact that the fish, dead or alive, must be positioned or swim into a specific position or through a specific conduit, often even at a specific speed, has been a major problem, since the fish is reluctant to swim into said positions or conduits. In practice, such measurements are only possible when the fish cage or similar equipment holding the fish is emptied for fish, as when transferring the fish to slaughtering, or by taking out a sample population for measurements.

The fish farmer would like to know the exact biomass of fish during the growing phase, in order to avoid overfeeding or underfeeding, as well as for finding the correct time for slaughtering, before selling the fish for slaughtering. Overfeeding cause spill of nutritious food with resulting effect on the environment and underfeeding cause thin, small fish. With accurate knowledge of the biomass, the feeding can be improved, providing a healthy and valuable population of fish and agreements with buyers of fish can be made without losses due to inaccurate mass of the fish. It is the biological mass, also termed biomass, in kg or other weight unit that are sold and to know the biomass is also essential for correct feeding.

A demand exists for technology mitigating the above mentioned or other problems. The present invention meets the demand.

### SUMMARY OF THE INVENTION

The invention provides an arrangement for measuring the biological mass of fish, the arrangement comprising a measurement unit and a processing unit operatively connected to or integrated in the measurement unit. The arrangement is distinctive in that the measurement unit measures and provides data for an outline of a fish passing or positioned in front of the measurement unit, the processing unit, by using an algorithm or a database or both, provides data on the biological mass of said fish.

With outline it is meant a line sketch or a contrasting shape representing a fish. The outline comprises at least one length measurement and at least one, preferably at least two, three, five, or more transverse distance measurements, and/or an area inside the fish outline in addition to at least one specific dimension, such as length or the largest or the midpoint transverse dimension. Preferably, transverse distance measurements are made for at least each centimeter of length and at least two length measurements are made. All measurements are made in a consistent way. Preferably, the resulting outline only includes the outline and optionally the length and transverse distance measurements, meaning that all other data, representing noise, has been filtered out. Alternatively, the outline can be an image comprising more data, such as a 3D image, however, such images comprises unnecessary data and experience show that the sources for errors increase and the accuracy decreases in practice for more complex image embodiments including outline of the fish in addition to much unnecessary data.

The outline of the fish can be found in several ways, the preferred steps are as described above. Alternative methods are to use existing programs, such as Microsoft Visio, or programs provided by Nikon or other camera companies, feasible to provide an outline. A typical critical parameter is sufficient contrast in the video, still pictures or timelapse provided by a camera or other optical device of the measurement unit. Data on the condition or shape of the fish, such as length, and one, two or more transverse distance measurements or area inside the fish outline combined with length or another specific dimension, are required in order to find the correct biomass at sufficient precision.

The measurement unit comprises a camera or a similar optical measurement device. More specifically, the measurement unit can in principle comprise any camera, with inherent distance information to the fish measured in the images or footage, or any camera with external distance measurement to the fish measured.

Preferably, the measurement unit comprises a stereovision film camera. This embodiment is preferable when the distance between the fish and the measurement unit is unknown, since a stereovision camera provides distance data useful to normalize the outline to a normalized distance, so the data are directly usable for an algorithm and/or database for finding the biomass.

Preferably, the measurement unit comprises a stereovision film camera and sources of in substance monochromatic light, built into a front end of a cylinder or other box submersible into a fish cage or other volume of water. Many suppliers of stereovision cameras exist, a feasible camera is Stereolabs ZED. Alternatively, a multivision camera, comprising more than two cameras and lenses and providing distance data, can be used. Alternatively, light sources are arranged separately.

Alternatively, the measurement unit comprises a monovision camera and at least one of the following:
the camera and fish are located in fixed positions or known distance apart,
the camera and fish are located in arbitrary positions or distance apart, wherein the camera comprises an autofocus function providing data on distance between fish and camera, and
the camera and fish are located in arbitrary positions or distance apart, wherein the arrangement comprises a separate device for providing data on distance between fish and camera.

The outline comprises, as a minimum, at least one length dimension of the fish measured and one specific transverse dimension. The specific transverse dimension is preferably largest height or mid-length height of the fish measured.

The length dimension preferably is from the front of the head to where the tail fin begins, as measured along the spine. The outline will, or can, also comprise an area, which area is as defined inside the outline defined by said dimensions, or provided otherwise. If present in the data, the area inside the outline, as combined with one or more specific dimension, such as length and/or mid-point or largest height, can providing the data for finding biological mass of the fish, alone or as combined with using said dimensions without using the area.

The arrangement preferably comprises a pattern recognition functionality, recognizing a relevant species of fish or/and a specific fish in correct orientation and position, and a function for creating an outline of said fish after a positive finding, by providing length and transverse dimensions across the length of the fish being measured, the transverse dimensions as assembled provides an outline of the fish, all other data are eliminated and the outline is used to calculate or find the biological mass of the fish.

As a preferable embodiment, the invention provides an arrangement for measuring the biological mass of fish, the arrangement comprising a measurement unit and a processing unit operatively connected to or integrated in the measurement unit, distinctive in that the measurement unit comprises one of:
a camera comprising an integrated autofocus function or an external distance measurement device providing data on distance between fish and camera, and
a stereovision film camera;
the measurement unit or the arrangement comprises sources of in substance monochromatic light, and
the processing unit comprises:
a pattern recognition functionality and function for creating an outline of said fish after a positive finding, the outline comprises length and at least one transverse dimension across the length of the fish being measured, or an area inside the outline and at least one of length and a transverse dimension across the length of the fish being measured, all other data are eliminated and the outline is used to calculate or find the biological mass of the fish.

The measurement unit measures and provides data for an outline of a fish passing or positioned in front of the measurement unit. The processing unit, by using an algorithm or a database or both and using the dimensions length and at least one transverse dimension of the fish, or at least one of said dimensions in combination with an area of said outline, provides data on the biological mass of said fish.

The invention also provides a method for measuring the biological mass of fish, using the arrangement of the invention. The method is distinctive by the steps:
to film or take still images of a fish passing or positioned in front of a measurement unit, using a camera or similar optical device of the measurement unit,
to recognize the fish, using software of a processing unit,
to create an outline of the recognized fish, using software of the processing unit, and
to provide data on the biological mass of said fish based on said outline, using the processing unit and algorithms and/or databases.

In a preferable embodiment, the invention provides a method for measuring the biological mass of fish, using the arrangement of the invention comprising a measurement unit and a processing unit operatively connected to or integrated in the measurement unit, distinctive by taking images or footage of fish using at least one of:
a camera comprising an autofocus function providing data on
distance between fish and camera, and
   a stereovision film camera;
whilst illuminating the fish with sources of in substance monochromatic light, and
sorting out all overlapping and incorrectly oriented and incorrectly positioned fish using a pattern recognition functionality,
creating an outline of said fish after a positive finding, by providing length and at least one transverse dimension across the length of the fish being measured, the transverse dimensions and the length as assembled provides an outline of the fish, all other data are eliminated and the outline is used to calculate or find the biological mass of the fish, using said dimensions or at least one of said dimensions and an area inside the outline, by using an algorithm or a database or both, to provide data on the biological mass of said fish.

The method preferably includes illuminating by light, preferably in substance monochromatic light of short wavelength, such as green, blue, violet or ultra violet. Green has proved to be very effective. The in substance monochromatic light reduces noise and shorter wavelengths penetrate further into water than longer wavelengths. For these reasons, the arrangement of the invention preferably comprises sources of light, preferably in substance monochromatic light such as green, blue, violet or ultra violet. In substance monochromatic light means light of distinct color, as mentioned, but comprising a band or specter of wavelengths. Narrow monochromatic light, as provided by lasers is less preferable since disturbing interference effects and other effects may cause problems.

If not fixed or already known, data on distance between fish and camera, as measured, is used to normalize the size of the outline of the fish, in order to provide correct biological mass, for each of the method of the invention and the arrangement of the invention.

The method preferably comprises using a pattern recognition functionality, to recognize a relevant species of fish; to create an outline of said fish after a positive finding, using a function providing an outline of the fish by providing length and transverse dimensions across the length of the fish being measured, or length and area, all other data are eliminated and the outline is used to calculate or find the biological mass of the fish, and the result is added as data accumulating into a report. Alternatively, measured length and area inside the outline is used to find the biological mass.

For the arrangement and the method of the invention, length and transverse dimensions are measured in a consistent way. The number of measurements or the resolution governs the accuracy. Preferably, the measurements do not include the fins of the fish, only the length and width of the skin.

For the arrangement and the method of the invention, the camera or cameras preferably record photos or film from the side of the fish. This means that the camera or cameras are in substance at the same elevation as the fish recorded. This also means that the fish to be measured preferably face the side towards the camera. This is in contrast to the teaching of patent NO 332 103, prescribing recording downwards in the water. For embodiments measuring fish from the side, the transverse dimensions are the height of the fish. The length is preferably the distance from the front of the head to where the tail fin begins and the skin ends. For alternative embodiments, measuring fish from above or below, the transverse dimensions are the width of the fish.

As mentioned, at least one transverse dimension is measured with each of the arrangement and the method of the invention, in addition to the length. The at least one transverse dimension preferably includes the largest transverse dimension of the fish measured, preferably the largest height, alternatively the largest width. For embodiments of the arrangement and/or method with only one or a few transverse dimensions measured, the dimension must be taken at accurate position or positions along the fish, such as at the mid point, ¼ and ¾ of the length.

For the arrangement and the method of the invention, all unnecessary data are preferably eliminated. This preferably includes elimination of any 3D model data. This preferably also includes elimination of the pixels representing a fish. Such elimination improves reliability and accuracy.

For embodiments of the arrangement and the method of the invention using a single camera with an autofocus function, the autofocus function preferably is or comprises a contrast based autofocus function, relying on that the contrast is highest when the fish is in focus, not including any distance measurement per se. Additional or alternative autofocus functions can include any known, functional technology, such as phase-based autofocus and/or illumination-based autofocus.

Preferably, a standardized measurement pattern is followed, with respect to time, time periods, positions and depths for making measurements, with the measurement unit submerged in fish cages or other units or water volumes containing the fish. Such consistency improves accuracy and reliability.

The invention also provides use of the arrangement of the invention, for measuring of biological mass of fish. Said use is preferably for measuring with the measurement unit as positioned and immersed in a fish cage or other water volume containing farmed fish or wild fish.

In addition, the invention provides use of the arrangement of the invention for detecting and quantifying a population of fish lice on fish. Testing show that the arrangement of the invention provides sufficient resolution or clarity to see, recognize and count the population of sea lice on fish, such as salmon lice on salmon, on the side of the fish that is imaged and measured. The other side of the fish will have about the same fish lice population. Particularly for the salmon farming industry, detection and quantification of lice population on the fish in the fish cage is crucial data.

### FIGURES

FIG. 1 illustrates an arrangement of the invention, as operated in a fish farm with the measurement unit immersed in a fish cage,

FIG. 2 illustrates the measurement unit in some detail, and

FIGS. 3a, 3b, 3c, 3d and 3e illustrate example images, as captured and as being processed to an outline.

### DETAILED DESCRIPTION

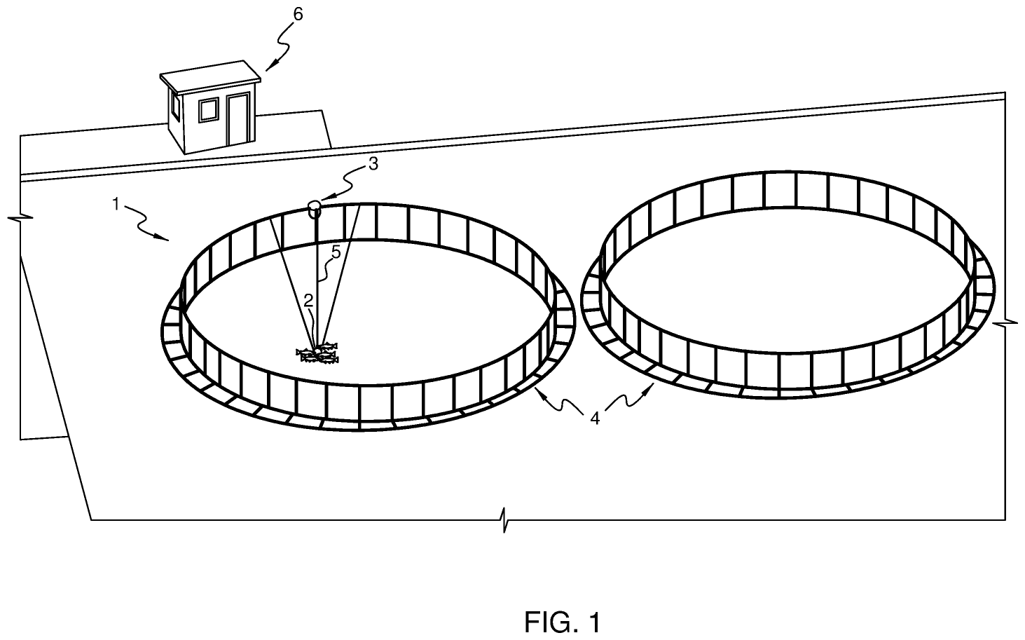

FIG. 1 illustrates an arrangement 1 of the invention, as operated in a fish farm with the measurement unit 2 immersed in a fish cage 4. In the illustrated embodiment, the processing unit 3 is arranged to a railing of the fish cage and is separate from the measurement unit. The measurement unit 2 and the processing unit 3 are connected by an umbilical or cable 5, the cable transfers power and signals. A control room 6 has communication via air link or other communication means to the processing unit. The layout of the arrangement of the invention can vary a lot. The measurement unit and the processing unit can be one combined unit, with communication via cable or air link or similar to a control facility that in principle can be located anywhere. With communication by air link or other wireless communication from each fish cage, and with existing provisions for power at each fish cage, it is easy to move the arrangement of the invention between fish cages. For arrangements with measurement units permanently installed for measuring in a fish cage, one or several permanently installed signal cables to the control room may be preferable.

The measurement unit in an arrangement of the invention preferably also includes means for measuring temperature. The measurement unit in an arrangement of the invention preferably also includes means for measuring depth or pressure of the measurement unit as immersed. Temperature will affect optical parameters and also the fish, which can be compensated for by measuring the temperature. Depth or pressure is a parameter fish is sensitive to and adapts to, likewise as for temperature, and by measuring said parameters certain effects can be compensated for and the data becomes more reliable and informative.

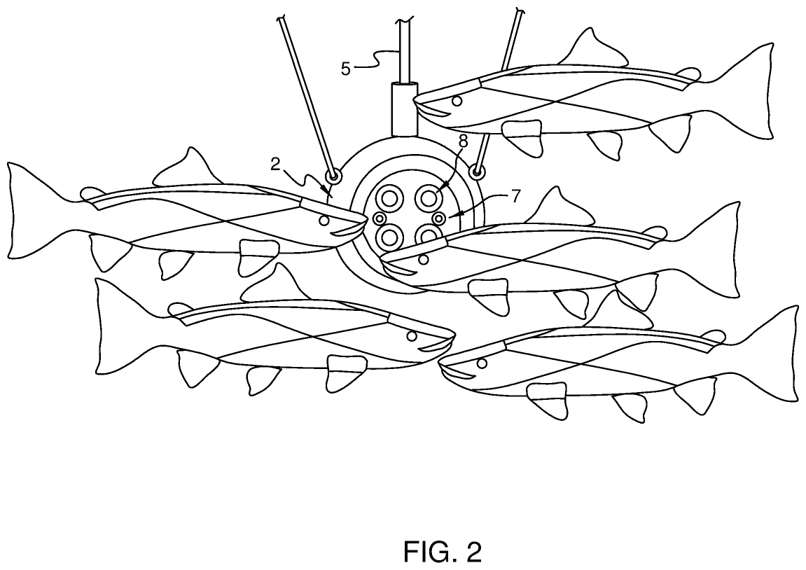

FIG. 2 illustrates an embodiment of the measurement unit 2 in some detail. More specifically, in a housing a stereovision camera 7 and four ring-shaped LED lights 8 are arranged at one end facing the fish to be measured. For clarity, reference numerical is indicated for only one of the two camera windows and only one of the four LED lights.

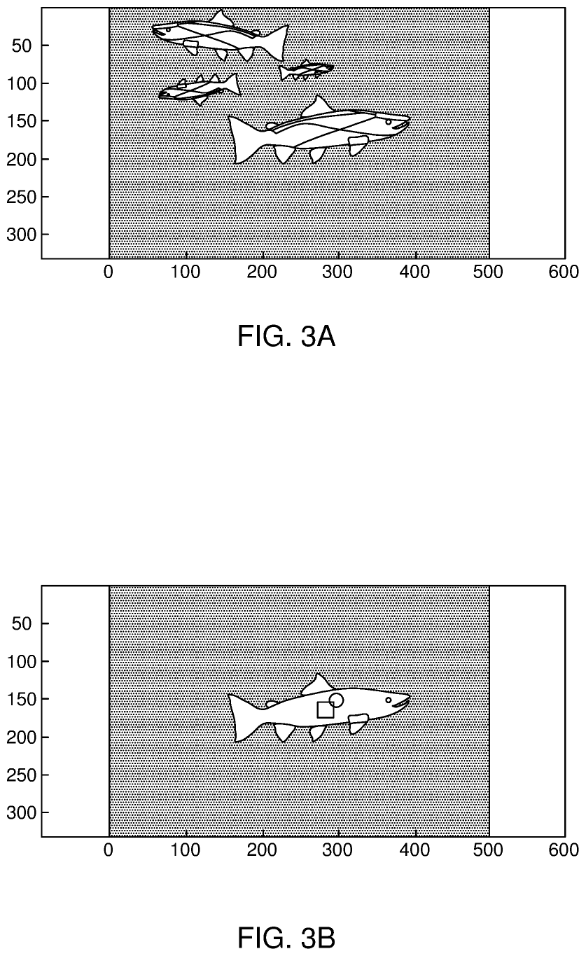

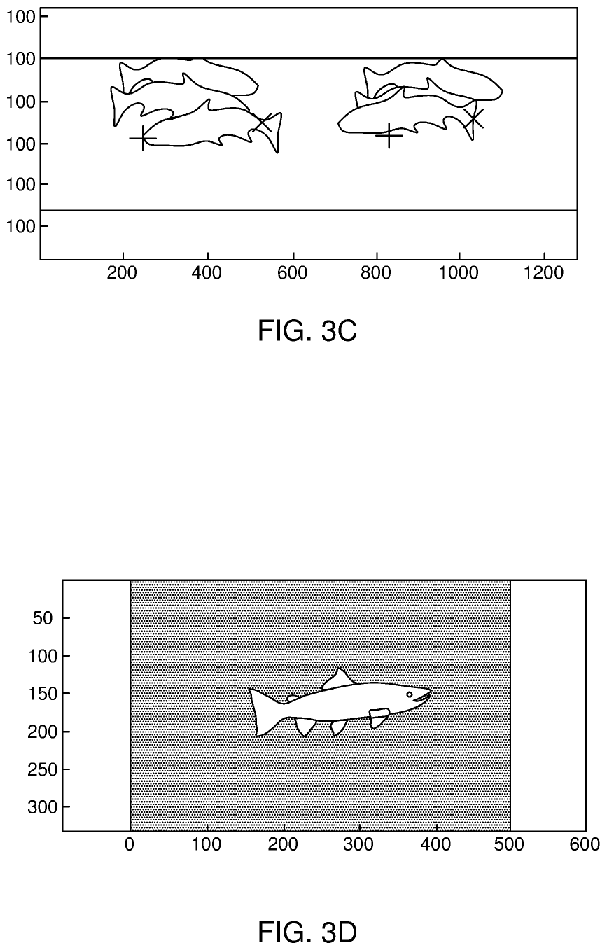

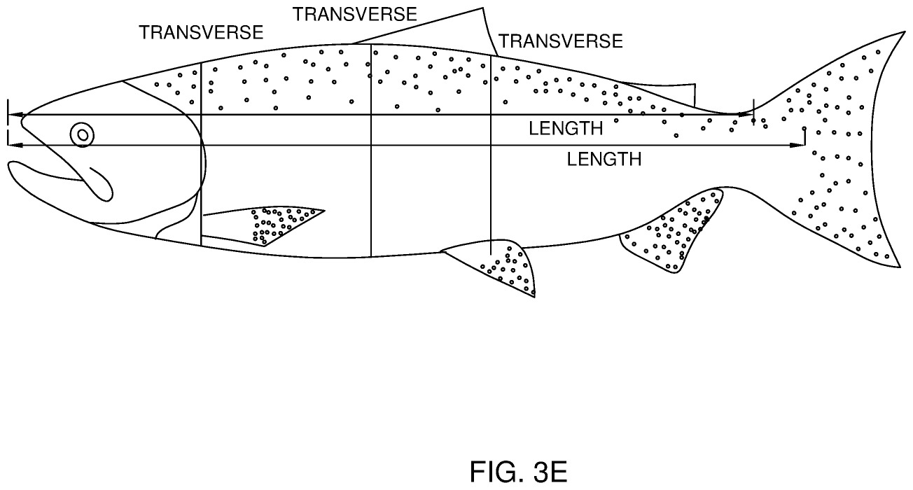

FIGS. 3a, 3b, 3c and 3d are real prototype example images, as captured and as being processed in order to provide an outline for finding the biomass of the fish. FIG. 3c is an original stereo frame, with white markings for the important points on the fish found, as well as measured length (mm) and estimated weight (g). A number of heights (transverse distances) will also be included in the final outline. FIG. 3a is an original frame (left eye) from the stereovision camera, after some threshold filtering. FIG. 3b illustrates a fish as detected by pattern recognition, with the fish segmented out. FIG. 3d illustrates the same fish as leveled to be horizontal. Such leveling is preferable, but not necessarily required, as a step in a normalization procedure of the method of the invention. FIG. 3e illustrates an outline with some examples on measured length and transverse dimensions. For consistency, the transverse dimensions will preferably be measured at consistent positions or length ratios along the length of the fish, for example at ½, ¼ and ¾ of the length as measured from the snout.

The approach of the software and method of the invention, in the illustrated embodiment of FIGS. 3a to 3e, can be described as:
Fish detection and segment out a fish based on illumination
Filter out all noise with performance-oriented tests for the fishes that are not complete or are over-complete (when groups of fish are “glued” together)
Outline of a fish
Depth estimation in head and tail area
Size estimation based on length and height (transverse distance measurements)
Weight/biomass estimation by using algorithm and/or a database
Add biomass estimation into a report

In the illustrated embodiment, the standard length of the fish is used for length measurement. The standard length is the distance from the tip of the snout to the posterior end of the last vertebra or to the posterior end of the midlateral portion of the hypural plate. Roughly explained in other words, the standard length is the distance from the tip of the nose to where the central part of the tail fin begins. Alternatively, the total length or the fork length can be used. However, it is crucial that the length measurement is consistent and in agreement with the length measurement of the algorithms and databases used for processing in order to find the biomass.

In general, and particularly for fish such as salmonids with highly reflective skin, providing good illumination and high contrast in the captured images or film, the standard length is preferably used. For fish species with dark skin or no particular distinctive color, other length measurements can be preferable. In addition to at least one reliable, consistent length measurement, at least one transverse distance measurement is required to provide sufficient data for finding an outline and the biomass of the fish. If only one transverse distance measurement is used, this is preferably from the midsection center or transverse along the girth of the fish. However, many transverse distances are preferably found and used, preferably so many that an outline of the fish is immediately recognizable by combining all measured distances in their respective position in an image. Preferably, the resolution of the images captured by the measurement unit is sufficiently high to allow recognizing and quantification of lice on fish being measured.

The arrangement of the invention comprises at least one measurement unit and at least one processing unit. The measurement unit comprises a camera or similar optical device for capturing images or film or both. The level of processing in the measurement unit can be anything from no processing to full processing, depending on the measurement and processing units being combined or not. In one embodiment, the processing unit can be a computer in a control room receiving raw data from the measurement unit. In other embodiments, the processing unit can be arranged in a transponder on the rail of the fish cage, as illustrated, only sending biomass data or reports to a control room or computer or other receiver of data. Any intermediate levels in between of processing are possible.

The arrangement of the invention can include any feature or step described or illustrated in the present document, in any operative combination, each such operative combination is an embodiment of the invention. The method of the invention can include any feature or step described or illustrated in the present document, in any operative combination, each such operative combination is an embodiment of the invention.

1. An arrangement for measuring the biological mass of fish, the arrangement comprising:
a measurement unit;
a processing unit operatively connected to or integrated in the measurement unit;
wherein the measurement unit comprises one of:
a camera comprising an integrated autofocus function or an external distance measurement device providing data on distance between fish and camera; and
a stereovision film camera;
the measurement unit or the arrangement comprises sources of in substance monochromatic light, and
wherein the processing unit comprises a pattern recognition functionality and function for creating an outline of the fish after a positive finding, the outline comprises length and at least one transverse dimension across the length of the fish being measured, or an area inside the outline and at least one of length and a transverse dimension across the length of the fish being measured, all other data are eliminated and the outline is used to calculate or find the biological mass of the fish.

2. The arrangement according to claim 1, wherein the measurement unit comprises a stereovision film camera.

3. The arrangement according to claim 1, wherein the measurement unit comprises a stereovision film camera and sources of in substance monochromatic light, built into a front end of a cylinder or other box submersible into a fish cage.

4. The arrangement according to claim 1, wherein the measurement unit comprises a monovision camera and at least one of the following:
the camera and fish are located in fixed positions or known distance apart;
the camera and fish are located in arbitrary positions or distance apart, wherein the camera comprises an autofocus function providing data on distance between fish and camera; and
the camera and fish are located in arbitrary positions or distance apart, wherein the arrangement comprises a separate device for providing data on distance between fish and camera.

5. The arrangement according to claim 1, comprising a pattern recognition functionality, recognizing a relevant species of fish, and a function for creating an outline of the fish after a positive finding, by providing length and transverse dimensions across the length of the fish being measured, the transverse dimensions as assembled provides an outline of the fish, all other data are eliminated and the outline is used to calculate or find the biological mass of the fish.

6. The method for measuring the biological mass of fish, using the arrangement of any one of claim 1, comprising:
to film or take still images of a fish passing or positioned in front of a measurement unit, using a camera or similar optical device of the measurement unit,
to recognize the fish, using software of a processing unit,
to create an outline of the recognized fish, using software of the processing unit, and
to provide data on the biological mass of the fish based on the outline, using the processing unit and algorithms or databases or both.

7. The method according to claim 6, wherein the fish is illuminated by light.

8. The method according to claim 6, wherein measured data on distance between fish and camera, if the data is not already known, is used to normalize the size of the outline of the fish, in order to provide correct biological mass.

9. The method according to claim 6, comprising:
using a pattern recognition functionality, to recognize a relevant species of fish;
to create an outline of the fish after a positive finding, using a function providing an outline of the fish by providing length and transverse dimensions across the length of the fish being measured, all other data are eliminated; and
using the outline to calculate or find the biological mass of the fish.

10. The method according to claim 6, whereby wherein a standardized measurement pattern is followed, with respect to time, time periods, positions and depths for making measurements, with the measurement unit submerged in fish cages or other volumes containing the fish.

11. (canceled)

12. (canceled)

13. (canceled)

14. The method according to claim 7, wherein the light is in substance monochromatic light of short wavelength.

15. The method according to claim 14, wherein the in substance monochromatic light is green, blue, violet, or ultra violet.

16. The method according to claim 9, comprising , adding a result of the method as data accumulating into a report.
